(19) United States
(12) Patent Application Publication
(10) Pub. No.: US 2026/0337445 A1
(43) Pub. Date: Oct. 29, 2026

(54) METHOD FOR FORMING MULTILAYERED COATING FILM

(71) Applicant: KANSAI PAINT CO., LTD., Hyogo (JP)

(72) Inventors: Nobuhiko NARITA, Kanagawa (JP); Kenji SAKAI, Kanagawa (JP); Takashi OZAWA, Kanagawa (JP)

(73) Assignee: KANSAI PAINT CO., LTD., Hyogo (JP)

(21) Appl. No.: 19/103,609

(22) PCT Filed: Aug. 23, 2023
(86) PCT No.: PCT/JP2023/030220

§ 371 Date: Feb. 13, 2025

(30) Foreign Application Priority Data
Aug. 24, 2022 (JP) 2022-132870

(51) Int. Cl. C09D 175/12; C09D 5/36; C09D 7/61; C09D 175/04; C23C 14/16; C23C 14/24; C23C 14/58

(52) U.S. Cl. CPC C09D 175/12; C09D 5/36; C09D 7/61; C09D 175/04; C23C 14/16; C23C 14/24; C23C 14/5806

(57) ABSTRACT

A method of forming a multilayered coating film,
the method including:
(1) forming an effect coating film by applying an effect coating composition (Y) containing an indium particle (y1) onto an object to be coated;
(2) forming a clear coating film by applying a clear coating composition (Z) containing a hydroxy group-containing acrylic resin (z1) and a polyisocyanate compound (z2) onto the effect coating film produced in (1); and
(3) curing the effect coating film and the clear coating film by heating, separately or simultaneously, the effect coating film formed in (1) and the clear coating film formed in (2),
wherein
the hydroxy group-containing acrylic resin (z1) has a hydroxyl value in a range from 10 to 75 mg KOH/g.

### TECHNICAL FIELD

The present invention relates to a method of forming a multilayered coating film.

### BACKGROUND ART

The purpose of applying a coating material is primarily to protect a material and impart an aesthetic appearance. For industrial products, aesthetic appearance, especially “texture”, is important from the viewpoint of increasing the product appeal. Textures of industrial products desired by consumers are diverse, but in recent years, lustrous feels, such as metal-like lustrous feels, are in demand in fields, such as automobile outer panels, automobile parts, and home electrical appliances (hereinafter described as “metallic luster”).

The metallic luster is a texture characterized by, like a specular surface, the absence of granularity. Furthermore, the coated plate having such a texture shines brilliantly when viewed from substantially perpendicular to the coated plate (highlight), but presents dark appearance when viewed from diagonally above of the coated plate (shade). That is, there is a large luminance difference between the highlight area and the shade area.

Techniques to impart such metallic luster to the surface of industrial products include metal plating processing and metal vapor deposition processing (e.g., see Patent Document 1). However, if a coating can provide metallic luster, it is advantageous from the viewpoints of ease of operation, cost, and the like.

Patent Document 2 describes that good metallic appearance can be provided by a metallic coating material produced by diluting a metallic coating base agent containing a nonvolatile solid component including an effect pigment and a resin and a solvent with a diluent containing a high-boiling-point solvent and a low-boiling-point solvent in a dilution ratio of 150 to 500%, and then adding from 5 to 10 parts by weight of a viscous resin with respect to 100 parts by weight of resin content in the metallic coating base agent.

However, the appearance formed by the metallic coating material described above does not have satisfactory metallic luster.

In addition, coating is required to protect a material in addition to imparting good appearance, and thus excellent coating performance such as high adhesiveness is needed.

### CITATION LIST

### Patent Document

Patent Document 1: JP S63-272544 A
Patent Document 2: JP 2003-313500 A

### SUMMARY OF INVENTION

### Technical Problem

An object of the present invention is to provide a method of forming a multilayered coating film whereby a multilayered coating film that has excellent metallic luster and high coating performance can be formed.

### Solution to Problem

The present invention encompasses the subject matter described in the following items.
Item 1. A method of forming a multilayered coating film,
the method including:
(1) forming an effect coating film by applying an effect coating composition (Y) containing an indium particle (y1) onto an object to be coated;
(2) forming a clear coating film by applying a clear coating composition (Z) containing a hydroxy group-containing acrylic resin (z1) and a polyisocyanate compound (z2) onto the effect coating film produced in (1); and
(3) curing the effect coating film and the clear coating film by heating, separately or simultaneously, the effect coating film formed in (1) and the clear coating film formed in (2),
wherein
the hydroxy group-containing acrylic resin (z1) has a hydroxyl value in a range from 10 to 75 mg KOH/g.
Item 2. The method of forming the multilayered coating film according to Item 1, wherein the effect coating composition (Y) further contains a hydroxy group-containing resin (y2)
Item 3. The method of forming the multilayered coating film according to Item 1 or 2, wherein the effect coating composition (Y) further contains a melamine resin (y3).
Item 4. The method of forming the multilayered coating film according to any one of Items 1 to 3, wherein an equivalent ratio (NCO/OH) of a total mol of an isocyanate group of the polyisocyanate compound (z2) to a total mol of a hydroxy group of the hydroxy group-containing acrylic resin (z1) is in a range from 0.7 to 1.5 in the clear coating composition (Z).

### Advantageous Effects of Invention

According to the method of forming a multilayered coating film of the present invention, a multilayered coating film that has excellent metallic luster and excellent coating performance such as adhesiveness can be formed.

### DESCRIPTION OF EMBODIMENTS

The method of forming a multilayered coating film of the present invention is a method of forming a multilayered coating film, the method including:
(1) forming an effect coating film by applying an effect coating composition (Y) containing an indium particle (y1) onto an object to be coated;
(2) forming a clear coating film by applying a clear coating composition (Z) containing a hydroxy group-containing acrylic resin (z1) and a polyisocyanate compound (z2) onto the effect coating film produced in (1); and
(3) curing the effect coating film and the clear coating film by heating, separately or simultaneously, the effect coating film formed in (1) and the clear coating film formed in (2),
wherein
the hydroxy group-containing acrylic resin (z1) has a hydroxyl value in a range from 10 to 75 mg KOH/g.

### Step (1)

According to the method of forming the multilayered coating film of the present invention, first, an effect coating composition (Y) containing an indium particle (y1) is applied on an object to be coated, and an effect coating film is formed.

### Object to be Coated

The object to be coated to which the effect coating composition (Y) is applied is not particularly limited. Examples of the object to be coated include outer panel parts of automobile bodies, such as those of passenger cars, trucks, motorcycles, and buses; automobile parts such as bumpers; outer panel parts of home electrical appliances, such as mobile phones and audio devices. In particular, outer panel parts of automobile bodies and automobile parts are preferred.

Materials of these objects to be coated are not particularly limited. Examples thereof include metal materials, such as iron, aluminum, brass, copper, tin plates, stainless steel, galvanized steel, and zinc alloy (such as Zn—Al, Zn—Ni, and Zn—Fe)-plated steel; resins, such as polyethylene resins, polypropylene resins, acrylonitrile-butadiene-styrene (ABS) resins, polyamide resins, acrylic resins, vinylidene chloride resins, polycarbonate resins, polyurethane resins, and epoxy resins; plastic materials, such as various FRPs; inorganic materials, such as glass, cement, and concrete; woods; and fiber materials, such as paper and cloth. In particular, a metal material and a plastic material are preferred.

A surface of the object to be coated to which the multilayered coating film is applied may be a metal surface of, for example, outer panel parts of automobile bodies, automobile parts, home electronics, metal substrates such as steel sheets and the like constituting the foregoing, the metal surface thereof having been subjected to a surface treatment, such as a phosphate salt treatment, a chromate treatment, or a composite oxide treatment.

A coating film may be further formed on an object that may or may not be surface-treated. For example, an object to be coated, which is a substrate, may be surface-treated optionally, and an undercoating film and/or an intermediate coating film may be formed on the treated surface. For example, when the object to be coated is an automobile body, the undercoating film and/or the intermediate coating film can be formed using coating compositions for undercoating and/or intermediate coating that are per se known and typically used in coating automobile bodies.

For example, an electrodeposition coating material, preferably a cationic electrodeposition coating material, can be used as the undercoating composition to form the undercoating film described above. A coating material that can be used as the intermediate coating composition for forming the intermediate coating film described above includes a coating material prepared using a base resin having a cross-linking functional group such as a carboxyl group or a hydroxy group (for example, an acrylic resin, a polyester resin, an alkyd resin, a urethane resin, and an epoxy resin); and a crosslinking agent, such as an amino resin (for example, a melamine resin and a urea resin), or a polyisocyanate compound that may be blocked; together with a pigment, a thickener, and an optional additional component.

### Effect Coating Composition (Y)

The effect coating composition (Y) is an effect coating composition containing an indium particle (y1).

The effect coating composition (Y) is preferably a coating composition containing an indium particle (y1) and further containing a surface conditioner and water and/or an organic solvent.

### Indium Particle (y1)

The indium particle (y1) is a flaky particle. The flaky particle may be also referred to as a scale-like particle, a sheet-like particle, or a flake-like particle.

In the present invention, a flaky particle means a particle having a substantially flat surface and a thickness in a direction perpendicular to the substantially flat surface is substantially uniform. The flaky particle means a particle with a shape, in which the thickness is extremely thin and a length of the substantially flat surface is extremely long. Note that the length of the substantially flat surface is a diameter of a circle having a projected area that is the same as a projected area of the flaky particle.

The shape of the substantially flat surface is not particularly limited and can be selected appropriately based on the purpose. Examples of the shape include a polygon such as a substantially rectangular, substantially square, substantially circular, substantially elliptical, substantially triangular, substantially quadrilateral, substantially pentagonal, substantially hexagonal, substantially heptagonal, or substantially octagonal shape, and a random irregular shape. Among these, a substantially circular shape is preferred.

The indium particles (y1) may form one layer or may form a primary particle with two or more layers layered therein. Furthermore, primary particles of the indium particles (y1) may aggregate to form a secondary particle.

Note that the indium particle (y1) is made of indium with a purity of 95% or greater, and may contain a trace amount of impurities but does not contain an alloy with another metal.

The indium particle (y1) described above can be produced by performing release layer formation, vacuum deposition, releasing, and, as necessary, another process.

### <Release Layer Formation>

Release layer formation is a process of providing a release layer on a substrate.

The substrate described above is not particularly limited as long as the substrate has a smooth surface, and various substrates can be used. Among these, a resin film, metal foil, or composite film of a metal foil and a resin film, having flexibility, heat resistance, solvent resistance, and dimensional stability can be suitably used. Examples of the resin film include a polyester film, a polyethylene film, a polypropylene film, a polystyrene film, and a polyimide film. Examples of the metal foil include copper foil, aluminum foil, nickel foil, iron foil, and alloy foil. Examples of the composite film of a metal foil and a resin film include a composite film produced by laminating the resin film and the metal foil described above.

As the release layer, various organic materials that can be dissolved in the releasing described below can be used. When the organic material constituting the release layer is appropriately selected, an organic material attached to and remained on an attachment face of island structure film can function as a protective layer of the indium particle (y1), which is preferable.

The protective layer has a function of suppressing aggregation of the indium particle (y1), oxidation of the indium particle (y1), flowing out of the indium particle (y1) into a solvent, and the like. In particular, using the organic material used for the release layer as a protective layer is preferred because surface treatment is not required to be additionally performed.

Examples of the organic material constituting the release layer that can be used as a protective layer include cellulose acetate butyrate (CAB) and other cellulose derivatives, polyvinyl alcohol, polyvinyl butyral, polyethylene glycol, polyacrylic acid, polyacrylamide, an acrylic acid copolymer, a modified nylon resin, polyvinylpyrrolidone, a urethane resin, a polyester resin, a polyether resin, and an alkyd resin. For these, a single type may be used alone or two or more types may be used in combination. Among these, from the viewpoint of high functionality as a protective layer, cellulose acetate butyrate (CAB) is preferred.

The forming method of the release layer is not particularly limited and can be appropriately selected based on the purpose. Examples of the method include an inkjet method, a blade coating method, a gravure coating method, a gravure offset coating method, a bar coating method, a roll coating method, a knife coating method, an air knife coating method, a comma coating method, a U comma coating method, an AKKU coating method, a smoothing coating method, a micro-gravure coating method, a reverse roll coating method, a four-roll coating method, a five-roll coating method, a dip coating method, a curtain coating method, a slide coating method, and a die coating method. For these, a single type may be used alone or two or more types may be used in combination.

### <Vacuum Deposition>

The vacuum deposition is a process of performing vacuum deposition of a metal layer containing an indium particle (y1) onto the release layer.

The average vapor deposition thickness of the metal layer containing the indium particle (y1) is preferably 60 nm or less, more preferably 55 nm or less, even more preferably 50 nm or less, and particularly preferably 45 nm or less. Note that the average vapor deposition thickness of the metal layer containing the indium particle (y1) is the same as the average thickness of the indium particle (y1).

When the average vapor deposition thickness of the metal layer is 60 nm or less, a surface roughness Ra of the coating film decreases, and excellent metallic luster can be exhibited, which is a benefit. The average vapor deposition thickness is determined by, for example, observing a cross-section of a metal layer, measuring thicknesses at 5 to 10 positions of the metal layer by using a scanning electron microscope (SEM), and averaging the measured thicknesses.

The metal layer is preferably an island structure film. The island structure film can be formed by various methods such as a vacuum deposition method, a sputtering method, and a plating method. Among these, a vacuum deposition method is preferred.

The vacuum deposition method is more preferred than the plating method from the viewpoints of being capable of forming a film on a resin substrate, generating no waste fluid, and the like, and is more preferred than the sputtering method from the viewpoints of being capable of setting a degree of vacuum high and achieving a high film formation rate (vapor deposition rate) and the like.

The vapor deposition rate in the vacuum deposition method is preferably 10 nm/sec or faster, and more preferably 10 nm/sec or faster and 80 nm/sec or slower.

### <Releasing>

The releasing is a process of releasing the metal layer from the substrate by dissolving the release layer. The solvent that can dissolve the release layer is not particularly limited as long as the solvent is a solvent that can dissolve the release layer, and can be appropriately selected based on the purpose; however, the solvent is preferably a solvent that can be used as is as a solvent for the effect coating composition (Y).

Examples of the solvent that can dissolve the release layer described above include an alcohol-based solvent such as methanol, ethanol, propanol, isopropanol, butanol, octanol, dodecanol, ethylene glycol, and propylene glycol; an ether-based solvent such as tetrahydron; a ketone-based solvent such as acetone, methyl ethyl ketone, and acetylacetone; an ester-based solvent such as methyl acetate, ethyl acetate, butyl acetate, and phenyl acetate; a glycol ether-based solvent such as ethyl cellosolve, butyl cellosolve, ethyl carbitol, butyl carbitol, ethylene glycol monomethyl ether, ethylene glycol monoethyl ether, ethylene glycol monoisopropyl ether, ethylene glycol monobutyl ether, ethylene glycol monohexyl ether, ethylene glycol monophenyl ether, diethylene glycol monomethyl ether, diethylene glycol monoethyl ether, diethylene glycol monobutyl ether, diethylene glycol dimethyl ether, diethylene glycol diethyl ether, triethylene glycol monomethyl ether, triethylene glycol monoethyl ether, triethylene glycol monobutyl ether, propylene glycol monomethyl ether, propylene glycol monoethyl ether, dipropylene glycol monomethyl ether, dipropylene glycol monoethyl ether, and diethylene glycol monomethyl ether acetate; a phenol-based solvent such as phenol and cresol; an aliphatic or aromatic hydrocarbon-based solvent such as pentane, hexane, heptane, octane, dodecane, tridecane, tetradecane, pentadecane, hexadecane, octadecane, octadecene, benzene, toluene, xylene, trimethine, nitrobenzene, aniline, methoxybenzene, and trimethine; an aliphatic or aromatic chlorinated hydrocarbon-based solvent such as dichloromethane, chloroform, trichloroethane, chlorobenzene, and dichlorobenzene; a sulfur-containing compound-based solvent such as dimethyl sulfoxide; and a nitrogen-containing compound-based solvent such as dimethylformamide, dimethylacetamide, acetonitrile, propionitrile, and benzonitrile. For these, a single type may be used alone or two or more types may be used in combination.

By dissolving the release layer, the island structure film is released from the substrate, then the island structure breaks up, and each island becomes an indium particle (y1). As a result, an indium particle (y1) dispersion liquid is produced particularly without performing crushing; however, as necessary, pulverization of the primary particle of the indium particle (y1) and classification may be performed. Furthermore, in a case where primary particles of indium particles (y1) are aggregated, as necessary, such an aggregate may be crushed.

Furthermore, as necessary, various treatments may be performed to recover the indium particle (y1) and to adjust the physical properties of the indium particle (y1). For example, the particle size of the indium particle (y1) may be adjusted by classification, recovery of the indium particle (y1) may be performed by a method such as centrifugal separation or suction filtration, and adjustment of a solid concentration of the dispersion liquid may be performed. In addition, solvent substitution may be performed, and viscosity adjustment and the like may be performed by using an additive.

### <Other Processes>

Examples of other processes include a process of taking out the released metal layer as a dispersion liquid, a process of recovering the island-like metal layer as the indium particle (y1) from the dispersion liquid, and the like.

From the viewpoint of forming a multilayered coating film having excellent metallic luster, a 50% cumulative volumetric particle size D50 of the indium particles (y1) produced by performing the release layer formation, the vacuum deposition, the releasing, and optional other processes described above is preferably 0.70 μm or less, more preferably 0.60 μm or less, even more preferably 0.50 μm or less, and particularly preferably 0.40 μm or less.

The indium particle (y1) described above may be a commercially available product. Examples of the commercially available product include “LeafPowder 49CJ-1120”, “LeafPowder 49CJ-1150”, “LeafPowder 49BJ-1120”, and “LeafPowder 49BJ-1150” (these available from Oike & Co., Ltd.).

From the viewpoint of producing a coating film having excellent metallic luster, the effect coating composition (Y) of the present invention contains the indium particle (y1) in an amount of preferably 50 parts by mass or greater, more preferably 70 parts by mass or greater, even more preferably in a range from 80 to 99.9 parts by mass, and particularly preferably in a range from 90 to 99.9 parts by mass, with respect to 100 parts by mass of the solid content of the effect coating composition (Y).

Examples of the surface conditioner include a surface conditioner such as a silicone-based surface conditioner, an acrylic surface conditioner, a vinyl-based surface conditioner, a fluorine-based surface conditioner, and an acetylenediol-based surface conditioner. Among these, from the viewpoint of producing a coating film having excellent metallic luster, a fluorine-based surface conditioner is preferably contained. For the surface conditioners described above, a single type can be used alone or two or more types may be used in appropriate combination.

Examples of the fluorine-based surface conditioner described above include a fluorine-based polymer and a fluorine-based oligomer, which contain a perfluoroalkyl group and a polyalkylene oxide group; and a fluorine-based polymer and a fluorine-based oligomer, which contain a perfluoroalkyl ether group and a polyalkylene oxide group.

Examples of the commercially available product of the fluorine-based surface conditioner described above include “LE-604” and “LE-605” (available from Kyoeisha Chemical Co., Ltd.), and “F-444” and “F-554” (available from DIC Corporation).

When the effect coating composition (Y) of the present invention contains a surface conditioner, from the viewpoint of producing a coating film having excellent metallic luster, the content of the surface conditioner is preferably from 0.01 to 2.0 parts by mass, more preferably from 0.05 to 1.5 parts by mass, and even more preferably from 0.1 to 1.0 part by mass, with respect to 100 parts by mass of the solid content of the effect coating composition (Y).

An organic solvent commonly used in coating materials can be used as the organic solvent. Specific examples thereof include an alcohol-based solvent such as methanol, ethanol, propanol, isopropanol, butanol, octanol, dodecanol, ethylene glycol, and propylene glycol; an ether-based solvent such as tetrahydron; a ketone-based solvent such as acetone, methyl ethyl ketone, and acetylacetone; an ester-based solvent such as methyl acetate, ethyl acetate, butyl acetate, and phenyl acetate; a glycol ether-based solvent such as ethyl cellosolve, butyl cellosolve, ethyl carbitol, butyl carbitol, ethylene glycol monomethyl ether, ethylene glycol monoethyl ether, ethylene glycol monoisopropyl ether, ethylene glycol monobutyl ether, ethylene glycol monohexyl ether, ethylene glycol monophenyl ether, diethylene glycol monomethyl ether, diethylene glycol monoethyl ether, diethylene glycol monobutyl ether, diethylene glycol dimethyl ether, diethylene glycol diethyl ether, triethylene glycol monomethyl ether, triethylene glycol monoethyl ether, triethylene glycol monobutyl ether, propylene glycol monomethyl ether, propylene glycol monoethyl ether, dipropylene glycol monomethyl ether, dipropylene glycol monoethyl ether, and diethylene glycol monomethyl ether acetate; a phenol-based solvent such as phenol and cresol; an aliphatic or aromatic hydrocarbon-based solvent such as pentane, hexane, heptane, octane, dodecane, tridecane, tetradecane, pentadecane, hexadecane, octadecane, octadecene, benzene, toluene, xylene, trimethine, nitrobenzene, aniline, methoxybenzene, and trimethine; an aliphatic or aromatic chlorinated hydrocarbon-based solvent such as dichloromethane, chloroform, trichloroethane, chlorobenzene, and dichlorobenzene; a sulfur-containing compound-based solvent such as dimethyl sulfoxide; and a nitrogen-containing compound-based solvent such as dimethylformamide, dimethylacetamide, acetonitrile, propionitrile, and benzonitrile. For these, a single type may be used alone or two or more types may be used in combination.

From the viewpoint of producing a coating film having excellent metallic luster, as the organic solvent described above, preferably at least one type of solvent selected from a glycol ether-based organic solvent and an alcohol-based organic solvent is contained, and more preferably a glycol ether-based organic solvent is contained.

When the effect coating composition (Y) of the present invention contains an organic solvent, from the viewpoint of producing a coating film having excellent metallic luster, the content of the organic solvent is preferably in a range from 85 to 99.9 parts by mass, more preferably in a range from 90 to 99.5 parts by mass, and even more preferably in a range from 95 to 99 parts by mass, with respect to 100 parts by mass of the total of all components of the effect coating composition (Y).

### Other Components

Optionally, the effect coating composition (Y) may further appropriately contain a pigment other than the indium particle (y1), a viscosity modifier, a binder resin, a cross-linking component, a pigment dispersant, an anti-settling agent, an ultraviolet absorber, a light stabilizer, and the like.

Examples of the pigment other than the indium particle (y1) described above include a color pigment, an effect pigment other than the indium particle (y1), and an extender pigment. For the pigments, a single type may be used alone or two or more types may be used in combination. Examples of the coloring pigment include titanium oxide, zinc oxide, carbon black, molybdenum red, Prussian blue, cobalt blue, azo-based pigments, phthalocyanine-based pigments, quinacridone-based pigments, isoindoline-based pigments, threne-based pigments, perylene-based pigments, dioxazine-based pigments, and diketopyrrolopyrrole-based pigments. Examples of the effect pigment other than the indium particle (y1) include a vapor-deposited metal flake pigment other than the indium particle (y1), an aluminum flake pigment, and a light interference pigment. Examples of the extender pigment include clay, kaolin, barium sulfate, barium carbonate, calcium carbonate, talc, silica, and alumina white.

In a case where the effect coating composition (Y) of the present invention contains a pigment other than the indium particle (y1), from the viewpoint of producing a coating film having excellent metallic luster, the content of the pigment is preferably in a range from 0.01 to 30 parts by mass, more preferably in a range from 0.05 to 20 parts by mass, and even more preferably in a range from 0.1 to 15 parts by mass, with respect to 100 parts by mass of the solid content of the effect coating composition (Y).

Examples of the viscosity modifier include a silica-based fine powder, a mineral-based viscosity modifier, a barium sulfate micronized powder, a polyamide-based viscosity modifier, an organic resin particulate viscosity modifier, a diurea-based viscosity modifier, a urethane-associative viscosity modifier, a poly(acrylic acid)-based viscosity modifier that is acrylic swelling-type, and a cellulose-based viscosity modifier.

Examples of the binder resin include a hydroxy group-containing resin (y2).

The hydroxy group-containing resin (y2) described above is a resin having at least one hydroxy group per molecule. As the hydroxy group-containing resin (y2), a wide variety of known resins can be used, and examples thereof include resins such as an acrylic resin having a hydroxy group, a polyester resin having a hydroxy group, an acryl-modified polyester resin having a hydroxy group, a polyether resin having a hydroxy group, a polycarbonate resin having a hydroxy group, a polyurethane resin having a hydroxy group, an epoxy resin having a hydroxy group, and an alkyd resin having a hydroxy group. For these resins, a single type may be used alone, or two or more types may be used in combination. Among these, the hydroxy group-containing resin (y2) preferably includes a hydroxy group-containing acrylic resin (y2-1) from the viewpoint of adhesiveness and the like of the coating film to be formed.

The hydroxy group-containing acrylic resin (y2-1) can be obtained, for example, by copolymerizing a hydroxy group-containing polymerizable unsaturated monomer and another polymerizable unsaturated monomer (a polymerizable unsaturated monomer other than the hydroxy group-containing polymerizable unsaturated monomer).

The hydroxy group-containing polymerizable unsaturated monomer described above is a compound having one or more hydroxy groups and one or more polymerizable unsaturated bonds per molecule. Examples of the hydroxy group-containing polymerizable unsaturated monomer include: monoesterified products of (meth)acrylic acid and a dihydric alcohol having from 2 to 8 carbons, such as 2-hydroxyethyl (meth)acrylate, 2-hydroxypropyl (meth)acrylate, 3-hydroxypropyl (meth)acrylate, and 4-hydroxybutyl (meth)acrylate; ¿-caprolactone modified products of the monoesterified products of (meth)acrylic acid and a dihydric alcohol having from 2 to 8 carbons; adducts of (meth)acrylic acid and an epoxy group-containing compound (e.g., “Cardura E10P” (trade name), available from Momentive Specialty Chemicals, glycidyl neodecanoate); N-hydroxymethyl (meth)acrylamide; allyl alcohols; and (meth)acrylates having a polyoxyethylene chain with a hydroxy group at a molecular terminal.

The other polymerizable unsaturated monomer that is copolymerizable with the hydroxy group-containing polymerizable unsaturated monomer described above may be monomers described in the following (1) to (6). For these polymerizable unsaturated monomers, a single type may be used alone or two or more types may be used in combination.

### (1) Acid Group-Containing Polymerizable Unsaturated Monomer

The acid group-containing polymerizable unsaturated monomer is a compound having one or more acid groups and one or more polymerizable unsaturated bonds per molecule. Examples of the monomer include: carboxyl group-containing monomers such as (meth)acrylic acid, crotonic acid, itaconic acid, maleic acid, and maleic anhydride; sulfonate group-containing monomers such as vinyl sulfonic acid and 2-sulfoethyl (meth)acrylate; and acidic phosphate-based monomers such as 2-(meth)acryloyloxyethyl acid phosphate, 2-(meth)acryloyloxypropyl acid phosphate, 2-(meth)acryloyloxy-3-chloropropyl acid phosphate, and 2-methacryloyloxyethylphenyl phosphoric acid. For these, a single type may be used or two or more types may be used in combination.

### (2) Esterified Product of Acrylic Acid or Methacrylic Acid and Monohydric Alcohol Having 1 to 20 Carbon Atoms

Specific examples thereof include methyl (meth)acrylate, ethyl (meth)acrylate, propyl (meth)acrylate, n-butyl (meth)acrylate, isobutyl (meth)acrylate, tert-butyl (meth)acrylate, 2-ethylhexyl (meth)acrylate, isooctyl (meth)acrylate, isomyristyl (meth)acrylate, stearyl (meth)acrylate, isostearyl acrylate, lauryl (meth)acrylate, tridecyl (meth)acrylate, tetrahydrofurfuryl (meth)acrylate, cyclohexyl (meth)acrylate, and isobornyl (meth)acrylate.

### (3) Aromatic Vinyl Monomer

Specific examples of the aromatic vinyl monomer include styrene, α-methylstyrene, and vinyltoluene.

When the aromatic vinyl monomer is used as a constituent component, a glass transition temperature of the resulting resin is increased, and a hydrophobic coating film having a high refractive index can be formed, so that it is possible to achieve an improvement effect of the finished appearance of the coating film due to increase of its gloss.

In a case where the aromatic vinyl monomer is used as a constituent component, a compounding proportion thereof is preferably in a range from 3 to 50 mass %, particularly in a range from 5 to 40 mass %, with respect to the total amount of the monomer components.

### (4) Glycidyl Group-Containing Polymerizable Unsaturated Monomer

The glycidyl group-containing polymerizable unsaturated monomer is a compound having one or more glycidyl groups and one or more polymerizable unsaturated bonds per molecule, and specific examples thereof include glycidyl acrylate and glycidyl methacrylate.

### (5) Polymerizable Unsaturated Bond-Containing and Nitrogen Atom-Containing Compound

Examples thereof include (meth)acrylamide, N,N-dimethyl (meth)acrylamide, N-[3-(dimethylamino) propyl](meth)acrylamide, N-butoxymethyl (meth)acrylamide, diacetone (meth)acrylamide, N,N-dimethylaminoethyl (meth)acrylate, vinylpyridine, vinylimidazole, acrylonitrile, and methacrylonitrile.

### (6) Other Vinyl Compounds

Examples of the other vinyl compounds include vinyl acetate, vinyl propionate, vinyl chloride, and versatic acid vinyl ester. Examples of the versatic acid vinyl ester include commercially available products “VeoVa 9” and “VeoVa 10” (trade names, available from Hexion).

The other polymerizable unsaturated monomers may be one type or two or more types of the monomers described in (1) to (6) above.

In the present invention, the polymerizable unsaturated monomer refers to a monomer having one or more (for example, 1 to 4) polymerizable unsaturated groups. The polymerizable unsaturated group means an unsaturated group that is radically polymerizable. Examples of such polymerizable unsaturated groups include a vinyl group, a (meth)acryloyl group, a (meth)acrylamide group, a vinyl ether group, an allyl group, a propenyl group, an isopropenyl group, and a maleimide group.

In the present specification, “(meth)acrylate” means an acrylate or a methacrylate. “(Meth)acrylic acid” means acrylic acid or methacrylic acid. “(Meth)acryloyl” means acryloyl or methacryloyl. Furthermore, “(meth)acrylamide” means acrylamide or methacrylamide.

The hydroxyl value of the hydroxy group-containing acrylic resin (y2-1) described above is preferably in a range from 30 to 200 mg KOH/g, more preferably in a range from 40 to 180 mg KOH/g, and particularly preferably in a range from 50 to 150 mg KOH/g, from the viewpoints of curability, water resistance, and the like.

The acid value of the hydroxy group-containing acrylic resin (y2-1) described above is preferably in a range from 0.5 to 15 mg KOH/g, more preferably in a range from 1 to 12 mg KOH/g, and particularly preferably in a range from 2 to 10 mg KOH/g, from the viewpoints of curability, water resistance, and the like.

From the viewpoints of finished appearance of the coating film, curability, and the like, the weight average molecular weight of the hydroxy group-containing acrylic resin (y2-1) described above is preferably in a range from 2000 to 50000, more preferably in a range from 3000 to 45000, and even more preferably in a range from 5000 to 40000.

Note that, in the present specification, the average molecular weight is a value calculated from a chromatogram measured by a gel permeation chromatograph calibrated with the molecular weight of standard polystyrene. For the gel permeation chromatograph, “HLC-8120 GPC” (available from Tosoh Corporation) is used. Gel permeation chromatography is performed using four columns “TSKgel G-4000HXL”, “TSKgel G-3000HXL”, “TSKgel G-2500HXL”, and “TSKgel G-2000HXL” (trade names, all available from Tosoh Corporation) under conditions of a mobile phase of tetrahydrofuran, a measurement temperature of 40 °C, a flow rate of 1 cc/min, and a detector of RI.

From the viewpoints of hardness of the coating film, finished appearance, and the like, the glass transition temperature of the hydroxy group-containing acrylic resin (y2-1) is preferably in a range from −50 to 60 °C, more preferably in a range from −20 to 50 °C, and particularly preferably in a range from 0 to 45 °C.

In the present specification, the glass transition temperature (°C) of the acrylic resin was calculated by the following equations.

1/Tg (K)=(W1/T1)+(W2/T2)+ . . . (1)

Tg (°C)=Tg (K)−273 (2)

In the equations, W1, W2, and so on are the mass fractions of the monomers used for copolymerization, and T1, T2, and so on are the Tg (K) of the homopolymers of the monomers.

Note that, T1, T2, and so on are values according to Polymer Handbook (Second Edition, J. Brandup, E. H. Immergut, ed.) III, pp. 139-179. The glass transition temperature (°C) used for cases where the Tg of the homopolymer of a monomer is unknown is assumed to be the static glass transition temperature, which is determined as follows for example. A sample is placed into a measuring cup of a differential scanning calorimeter “DSC-220U” (available from Seiko Instruments, Inc.), and vacuum suction is performed to completely remove the solvent; then the change in heat quantity is measured in a range from −20 °C to +200 °C at a temperature increase rate of 3 °C/min, and the change point of the initial baseline at the low-temperature end is recorded as the static glass transition temperature.

A copolymerization method of providing the hydroxy group-containing acrylic resin (y2-1) by copolymerizing the monomer mixture described above is not particularly limited, and known copolymerization methods can be used. Among them, it is possible to suitably use a solution polymerization method in which polymerization is performed in an organic solvent in the presence of a polymerization initiator.

Examples of the organic solvent used in the solution polymerization method described above include: an aromatic solvent such as toluene, xylene, and Swasol 1000 (available from Cosmo Oil Co., Ltd., trade name, high boiling point petroleum-based solvent); an ester-based solvent such as ethyl acetate, butyl acetate, propyl propionate, butyl propionate, 1-methoxy-2-propyl acetate, 2-ethoxyethyl propionate, 3-methoxybutyl acetate, ethylene glycol ethyl ether acetate, and propylene glycol methyl ether acetate; a ketone-based solvent such as methyl ethyl ketone, methyl isobutyl ketone, and methyl amyl ketone, and an alcohol-based solvent such as isopropanol, n-butanol, isobutanol, and 2-ethyl hexanol.

For these organic solvents, a single type may be used alone or two or more types may be used in combination, but it is preferable to use an ester-based solvent or a ketone-based solvent from the viewpoint of solubility of the acrylic resin. Furthermore, an aromatic solvent may be suitably used in combination with these organic solvents.

Examples of the polymerization initiator that can be used in the copolymerization of the hydroxy group-containing acrylic resin (y2-1) include known radical polymerization initiators such as 2,2′-azobisisobutyronitrile, benzoyl peroxide, di-t-butyl peroxide, di-t-amyl peroxide, t-butyl peroctoate, 2,2′-azobis(2-methylbutyronitrile), and 2,2′-azobis(2,4-dimethylvaleronitrile).

In a case where the effect coating composition (Y) of the present invention contains the hydroxy group-containing acrylic resin (y2-1) as the hydroxy group-containing resin (y2), from the viewpoint of forming a multilayered coating film having excellent metallic luster and having excellent coating performance such as adhesiveness, the content of the hydroxy group-containing acrylic resin (y2-1) is preferably in a range from 50 to 100 mass %, more preferably in a range from 55 to 100 mass %, and even more preferably in a range from 60 to 100 mass %, with respect to the solid content of the hydroxy group-containing resin (y2).

In a case where the effect coating composition (Y) of the present invention contains the hydroxy group-containing resin (y2), from the viewpoint of forming a multilayered coating film having excellent metallic luster and having excellent coating performance such as adhesiveness, the content of the hydroxy group-containing resin (y2) is preferably in a range from 0.1 to 15 parts by mass, more preferably in a range from 0.5 to 12 parts by mass, and even more preferably in a range from 1 to 10 parts by mass, with respect to 100 parts by mass of the solid content of the effect coating composition (Y).

Examples of the cross-linking component include a melamine resin (y3), a melamine resin derivative, a urea resin, (meth)acrylamide, polyaziridine, polycarbodiimide, and a blocked or unblocked polyisocyanate compound. Among these, from the viewpoint of adhesiveness of the resulting coating film and the like, the melamine resin (y3) is preferably contained.

The melamine resin (y3) described above may be a partially methylolated melamine resin or a fully methylolated melamine resin produced by a reaction of a melamine component with an aldehyde component. Examples of the aldehyde component include formaldehyde, paraformaldehyde, acetaldehyde, and benzaldehyde.

As the melamine resin (y3), a compound in which methylol groups of the methylolated melamine resin described above are partially or fully etherified with an appropriate alcohol can be also used. Examples of the alcohol used in the etherification include methyl alcohol, ethyl alcohol, n-propyl alcohol, i-propyl alcohol, n-butyl alcohol, i-butyl alcohol, 2-ethyl-1-butanol, and 2-ethyl-1-hexanol.

The melamine resin (y3) is preferably a methyl-etherified melamine resin in which methylol groups of a partially or fully methylolated melamine resin are partially or fully etherified with methyl alcohol, a butyl-etherified melamine resin in which methylol groups of a partially or fully methylolated melamine resin are partially or fully etherified with butyl alcohol, or a methyl-butyl mixed etherified melamine resin in which methylol groups of a partially or fully methylolated melamine resin are partially or fully etherified with methyl alcohol and butyl alcohol, and more preferably a methyl-butyl mixed etherified melamine resin.

The melamine resin (y3) has a weight-average molecular weight of preferably from 400 to 6000, more preferably from 500 to 4000, and even more preferably from 600 to 3000.

As the melamine resin (y3), a commercially available product can be used. Examples of the commercially available products are under the following product names: “CYMEL 202”, “CYMEL 203”, “CYMEL 204”, “CYMEL 211”, “CYMEL 212”, “CYMEL 238”, “CYMEL 251”, “CYMEL 253”, “CYMEL 254”, “CYMEL 303”, “CYMEL 323”, “CYMEL 324”, “CYMEL 325”, “CYMEL 327”, “CYMEL 350”, “CYMEL 370”, “CYMEL 380”, “CYMEL 385”, “CYMEL 1156”, “CYMEL 1158”, “CYMEL 1116”, and “CYMEL 1130” (all manufactured by Allnex Japan Inc.); “RESIMENE 735”, “RESIMENE 740”, “RESIMENE 741”, “RESIMENE 745”, “RESIMENE 746”, and “RESIMENE 747” (all manufactured by Monsanto Company); “U-VAN 120”, “U-VAN 20HS”, “U-VAN 20SE”, “U-VAN 2021”, “U-VAN 2028”, and “U-VAN 28-60” (all manufactured by Mitsui Chemicals, Inc.); and “SUMIMAL M55”, “SUMIMAL M30W”, and “SUMIMAL M50W” (all manufactured by Sumitomo Chemical Co., Ltd.).

In a case where the effect coating composition (Y) of the present invention contains the melamine resin (y3), from the viewpoint of forming a multilayered coating film having excellent metallic luster and having excellent coating performance such as adhesiveness, the content of the melamine resin (y3) is preferably in a range from 0.1 to 10 parts by mass, more preferably in a range from 0.3 to 8 parts by mass, and even more preferably in a range from 0.5 to 5 parts by mass, with respect to 100 parts by mass of the solid content of the effect coating composition (Y).

The effect coating composition (Y) can be applied according to a common method, such as air spray coating, airless spray coating, and rotary atomization coating. When the effect coating composition (Y) is applied, static electricity may be applied optionally, and among methods for doing so, electrostatic coating by rotary atomization and electrostatic coating by air spraying are preferred, and electrostatic coating by rotary atomization is particularly preferred.

When the effect coating composition (Y) is applied by air spray coating, airless spray coating, or rotary atomization coating, the effect coating composition (Y) preferably appropriately contains water and/or an organic solvent and, optionally, an additive such as a defoamer, to adjust the solid content and viscosity to be suitable for coating.

From the viewpoint of forming a multilayered coating film having excellent metallic luster and having excellent coating performance such as adhesiveness, the solid content of the effect coating composition (Y) of the present invention is preferably in a range from 0.1 to 15 mass %, more preferably in a range from 0.5 to 10 mass %, and even more preferably in a range from 1 to 5 mass %.

From the viewpoint of forming a multilayered coating film having excellent metallic luster and excellent coating performance such as adhesiveness, the viscosity of the effect coating composition (Y) at 20 °C is preferably approximately in a range from 8 to 30 seconds, and particularly preferably in a range from 10 to 25 seconds, as determined using a Ford viscosity cup No. 3 as a viscometer.

From the viewpoint of forming a multilayered coating film having excellent metallic luster and having excellent coating performance such as adhesiveness, the cured film thickness of the effect coating film is preferably approximately from 0.01 to 2 μm, more preferably from 0.025 to 1 μm, and even more preferably approximately from 0.05 to 0.5 μm.

### Step (2)

According to the method of forming a multilayered coating film of the present invention, next, a clear coating composition (Z) containing a hydroxy group-containing acrylic resin (z1) and a polyisocyanate compound (z2) is applied on the effect coating film produced in (1), and thus a clear coating film is formed.

### Hydroxy Group-Containing Acrylic Resin (z1)

The hydroxy group-containing acrylic resin (z1) is an acrylic resin having at least one hydroxy group per molecule and has a hydroxyl value in a range from 10 to 75 mg KOH/g. When the hydroxyl value of the hydroxy group-containing acrylic resin (z1) is less than 10 mg KOH/g, adhesiveness of the multilayered coating film to be formed becomes poor. When the hydroxyl value of the hydroxy group-containing acrylic resin (z1) is more than 75 mg KOH/g, adhesiveness of the multilayered coating film to be formed becomes poor. In particular, from the viewpoints of adhesiveness of the multilayered coating film to be formed, miscibility with the polyisocyanate compound (z2), and the like, the hydroxyl value of the hydroxy group-containing acrylic resin (z1) is preferably in a range from 12 to 70 mg KOH/g, and more preferably in a range from 15 to 65 mg KOH/g.

The hydroxy group-containing acrylic resin (z1) can be produced, for example, by copolymerizing a hydroxy group-containing polymerizable unsaturated monomer and another polymerizable unsaturated monomer (polymerizable unsaturated monomer other than the hydroxy group-containing polymerizable unsaturated monomer) by a method known per se, such as a solution polymerization method in an organic solvent or an emulsion polymerization method in water.

As the hydroxy group-containing polymerizable unsaturated monomer and such another polymerizable unsaturated monomer described above, a compound described for the explanation of the hydroxy group-containing acrylic resin (y2-1) can be used.

From the viewpoint of adhesiveness of the multilayered coating film to be formed and the like, the hydroxy group-containing acrylic resin (z1) described above preferably has a weight-average molecular weight preferably in a range from 2000 to 50000, more preferably in a range from 3000 to 45000, and even more preferably in a range from 5000 to 40000.

From the viewpoints of finished appearance and adhesiveness of the resulting multilayered coating film, the pot life of the clear coating composition (Z), and the like, the acid value of the hydroxy group-containing acrylic resin (z1) is preferably 30 mg KOH/g or less, and particularly preferably in a range from 1 to 20 mg KOH/g.

From the viewpoints of adhesiveness, chipping resistance, finished appearance, and the like of the multilayered coating film that is formed, the hydroxy group-containing acrylic resin (z1) has a glass transition temperature preferably in a range from −50 to 60 °C, more preferably in a range from −30 to 50 °C, and particularly preferably in a range from −10 to 45 °C.

As a copolymerization method of producing the hydroxy group-containing acrylic resin (z1) by copolymerizing the polymerizable unsaturated monomer mixture described above, it is possible to suitably use a solution polymerization method in which polymerization is performed in an organic solvent in the presence of a polymerization initiator.

Examples of the organic solvent that is used during the solution polymerization method described above include an alcohol-based solvent such as methanol, ethanol, propanol, isopropanol, butanol, octanol, dodecanol, ethylene glycol, and propylene glycol; an ether-based solvent such as tetrahydron; a ketone-based solvent such as acetone, methyl ethyl ketone, and acetylacetone; an ester-based solvent such as methyl acetate, ethyl acetate, butyl acetate, and phenyl acetate; a glycol ether-based solvent such as ethyl cellosolve, butyl cellosolve, ethyl carbitol, butyl carbitol, ethylene glycol monomethyl ether, ethylene glycol monoethyl ether, ethylene glycol monoisopropyl ether, ethylene glycol monobutyl ether, ethylene glycol monohexyl ether, ethylene glycol monophenyl ether, diethylene glycol monomethyl ether, diethylene glycol monoethyl ether, diethylene glycol monobutyl ether, diethylene glycol dimethyl ether, diethylene glycol diethyl ether, triethylene glycol monomethyl ether, triethylene glycol monoethyl ether, triethylene glycol monobutyl ether, propylene glycol monomethyl ether, propylene glycol monoethyl ether, dipropylene glycol monomethyl ether, dipropylene glycol monoethyl ether, and diethylene glycol monomethyl ether acetate; a phenol-based solvent such as phenol and cresol; an aliphatic or aromatic hydrocarbon-based solvent such as pentane, hexane, heptane, octane, dodecane, tridecane, tetradecane, pentadecane, hexadecane, octadecane, octadecene, benzene, toluene, xylene, trimethine, nitrobenzene, aniline, methoxybenzene, and trimethine; and an aliphatic or aromatic chlorinated hydrocarbon-based solvent such as dichloromethane, chloroform, trichloroethane, chlorobenzene, and dichlorobenzene.

Examples of the polymerization initiator that can be used in the copolymerization of the hydroxy group-containing acrylic resin (z1) include known radical polymerization initiators such as 2,2′-azobisisobutyronitrile, benzoyl peroxide, di-t-butyl peroxide, di-t-amyl peroxide, t-butyl peroctoate, 2,2′-azobis(2-methylbutyronitrile), and 2,2′-azobis(2,4-dimethylvaleronitrile).

For the hydroxy group-containing acrylic resin (z1) described above, a single type may be used alone or two or more types may be used in combination.

### Polyisocyanate Compound (z2)

The polyisocyanate compound (z2) is a compound having at least two isocyanate groups per molecule, and examples thereof include an aliphatic polyisocyanate, an alicyclic polyisocyanate, an aromatic-aliphatic polyisocyanate, an aromatic polyisocyanate, and a derivative of the polyisocyanate.

Examples of the aliphatic polyisocyanates described above include aliphatic diisocyanates, such as trimethylene diisocyanate, tetramethylene diisocyanate, hexamethylene diisocyanate, pentamethylene diisocyanate, 1,2-propylene diisocyanate, 1,2-butylene diisocyanate, 2,3-butylene diisocyanate, 1,3-butylene diisocyanate, 2,4,4- or 2,2,4-trimethylhexamethylene diisocyanate, dimer acid diisocyanate, and methyl 2,6-diisocyanatohexanoate (common name: lysine diisocyanate); and aliphatic triisocyanates, such as 2-isocyanatoethyl 2,6-diisocyanatohexanoate, 1,6-diisocyanato-3-isocyanatomethylhexane, 1,4,8-triisocyanatooctane, 1,6,11-triisocyanatoundecane, 1,8-diisocyanato-4-isocyanatomethyloctane, 1,3,6-triisocyanatohexane, and 2,5,7-trimethyl-1,8-diisocyanato-5-isocyanatomethyloctane.

Examples of the alicyclic polyisocyanates include alicyclic diisocyanates, such as 1,3-cyclopentene diisocyanate, 1,4-cyclohexane diisocyanate, 1,3-cyclohexane diisocyanate, 3-isocyanatomethyl-3,5,5-trimethylcyclohexyl isocyanate (common name: isophorone diisocyanate), 4-methyl-1,3-cyclohexylene diisocyanate (common name: hydrogenated TDI), 2-methyl-1,3-cyclohexylene diisocyanate, 1,3- or 1,4-bis(isocyanatomethyl)cyclohexane (common name: hydrogenated xylylene diisocyanate) or its mixture, methylenebis(4,1-cyclohexanediyl) diisocyanate (common name: hydrogenated MDI), and norbornane diisocyanate; and alicyclic triisocyanates, such as 1,3,5-triisocyanatocyclohexane, 1,3,5-trimethylisocyanatocyclohexane, 2-(3-isocyanatopropyl)-2,5-di(isocyanatomethyl)-bicyclo(2.2.1)heptane, 2-(3-isocyanatopropyl)-2,6-di(isocyanatomethyl)-bicyclo(2.2.1)heptane, 3-(3-isocyanatopropyl)-2,5-di(isocyanatomethyl)-bicyclo(2.2.1)heptane, 5-(2-isocyanatoethyl)-2-isocyanatomethyl-3-(3-isocyanatopropyl)-bicyclo(2.2.1)heptane, 6-(2-isocyanatoethyl)-2-isocyanatomethyl-3-(3-isocyanatopropyl)-bicyclo(2.2.1)heptane, 5-(2-isocyanatoethyl)-2-isocyanatomethyl-2-(3-isocyanatopropyl)-bicyclo(2.2.1)-heptane, and 6-(2-isocyanatoethyl)-2-isocyanatomethyl-2-(3-isocyanatopropyl)-bicyclo(2.2.1)heptane.

Examples of the aromatic-aliphatic polyisocyanates include aromatic-aliphatic diisocyanates, such as methylenebis(4,1-phenylene) diisocyanate (common name: MDI), 1,3- or 1,4-xylylene diisocyanate or its mixture, ω,ω′-diisocyanato-1,4-diethylbenzene, and 1,3- or 1,4-bis(1-isocyanato-1-methylethyl)benzene (common name: tetramethylxylylene diisocyanate) or its mixture; and aromatic-aliphatic triisocyanates, such as 1,3,5-triisocyanatomethylbenzene.

Examples of the aromatic polyisocyanates include aromatic diisocyanates, such as m-phenylene diisocyanate, p-phenylene diisocyanate, 4,4′-diphenyl diisocyanate, 1,5-naphthalene diisocyanate, 2,4-tolylene diisocyanate (common name: 2,4-TDI) or 2,6-tolylene diisocyanate (common name: 2,6-TDI) or its mixture, 4,4′-toluidine diisocyanate, and 4,4′-diphenyl ether diisocyanate; aromatic triisocyanates, such as triphenylmethane-4,4′,4″-triisocyanate, 1,3,5-triisocyanatobenzene, and 2,4,6-triisocyanatotoluene; and aromatic tetraisocyanates, such as 4,4′-diphenylmethane-2,2′,5,5′-tetraisocyanate.

Examples of the derivatives of the polyisocyanates include dimers, trimers, biuret, allophanate, uretdione, uretoimine, isocyanurates, oxadiazinetrione, and polymethylene polyphenyl polyisocyanates (crude MDI and polymeric MDI), and crude TDI of the polyisocyanates described above.

The polyisocyanates and their derivatives described above may be used alone or in combination of two or more types.

Examples that can be suitably used include hexamethylene diisocyanate-based compounds among the aliphatic diisocyanates and 4,4′-methylenebis(cyclohexyl isocyanate) among the alicyclic diisocyanates. Among these, a derivative of hexamethylene diisocyanate is optimal from the viewpoint of adhesiveness and compatibility.

Examples of the polyisocyanate compound (z2) that may be used include prepolymers formed by reacting the polyisocyanate or its derivative described above with a compound having an active hydrogen group, such as a hydroxy group or an amino group, which can react with the polyisocyanate, under conditions of excess isocyanate groups. Examples of the compound that can react with the polyisocyanate include polyhydric alcohols, low molecular weight polyester resins, amines, and water.

In addition, examples of the polyisocyanate compound (z2) also include blocked polyisocyanate compounds, which are compounds formed by blocking an isocyanate group in the polyisocyanate and its derivative described above with a blocking agent.

Examples of the blocking agent described above include phenolic compounds, such as phenol, cresol, xylenol, nitrophenol, ethylphenol, hydroxydiphenyl, butylphenol, isopropylphenol, nonylphenol, octylphenol, and methyl hydroxybenzoate; lactam-based compounds, such as ε-caprolactam, δ-valerolactam, γ-butyrolactam, and β-propiolactam; aliphatic alcohol-based compounds, such as methanol, ethanol, propyl alcohol, butyl alcohol, amyl alcohol, and lauryl alcohol; ether-based compounds, such as ethylene glycol monomethyl ether, ethylene glycol monoethyl ether, ethylene glycol monobutyl ether, diethylene glycol monomethyl ether, diethylene glycol monoethyl ether, propylene glycol monomethyl ether, and methoxymethanol; alcohol-based compounds, such as benzyl alcohol, glycolic acid, methyl glycolate, ethyl glycolate, butyl glycolate, lactic acid, methyl lactate, ethyl lactate, butyl lactate, methylol urea, methylol melamine, diacetone alcohol, 2-hydroxyethyl acrylate, and 2-hydroxyethyl methacrylate; oxime-based compounds, such as formamide oxime, acetoamide oxime, acetoxime, methyl ethyl ketoxime, diacetyl monoxime, benzophenone oxime, and cyclohexane oxime; active methylene-based compounds, such as dimethyl malonate, diethyl malonate, ethyl acetoacetate, methyl acetoacetate, and acetylacetone; mercaptan-based compounds, such as butyl mercaptan, t-butyl mercaptan, hexyl mercaptan, t-dodecyl mercaptan, 2-mercaptobenzothiazole, thiophenol, methylthiophenol, and ethylthiophenol; acid amide-based compounds, such as acetanilide, acetanisidide, acetotoluide, acrylamide, methacrylamide, acetic amide, stearic amide, and benzamide; imide-based compounds, such as succinimide, phthalimide, and maleimide; amine-based compounds, such as diphenylamine, phenylnaphthylamine, xylidine, N-phenylxylidine, carbazole, aniline, naphthylamine, butylamine, dibutylamine, and butylphenylamine; imidazole-based compounds, such as imidazole and 2-ethylimidazole; urea-based compounds, such as urea, thiourea, ethyleneurea, ethylenethiourea, and diphenylurea; carbamic ester-based compounds, such as phenyl N-phenylcarbamate; imine-based compounds, such as ethyleneimine and propyleneimine; sulfite-based compounds, such as sodium bisulfite and potassium bisulfite; and azole-based compounds. Examples of the azole-based compounds described above include pyrazole or pyrazole derivatives, such as pyrazole, 3,5-dimethylpyrazole, 3-methylpyrazole, 4-benzyl-3,5-dimethylpyrazole, 4-nitro-3,5-dimethylpyrazole, 4-bromo-3,5-dimethylpyrazole, and 3-methyl-5-phenylpyrazole; imidazole or imidazole derivatives, such as imidazole, benzimidazole, 2-methylimidazole, 2-ethylimidazole, and 2-phenylimidazole; and imidazoline derivatives, such as 2-methylimidazoline and 2-phenylimidazoline.

When blocking is performed (when the blocking agent is allowed to react), a solvent can be added optionally.

The polyisocyanate compound (22) can be used alone or in combination of two or more.

In the clear coating composition (Z), from the viewpoint of forming a multilayered coating film having excellent coating performance such as adherence, an equivalent ratio (NCO/OH) of a total mol of an isocyanate group of the polyisocyanate compound (z2) to a total mol of a hydroxy group of the hydroxy group-containing acrylic resin (z1) is preferably in a range from 0.70 to 1.50, more preferably in a range from 0.75 to 1.40, and even more preferably in a range from 0.8 to 1.20.

The clear coating composition (Z) can appropriately and optionally contain: a solvent, such as water or an organic solvent; a resin other than the hydroxy group-containing acrylic resin (z1); a curing agent other than the polyisocyanate compound (z2); or an additive for a coating material, such as a curing catalyst, a defoamer, an ultraviolet absorber, a rheology control agent, and an antisettling agent.

The clear coating composition (Z) can appropriately contain a coloring pigment in a range that does not impair the transparency of the coating film. As the coloring pigment, a pigment known for an ink or for a coating material can be used alone, or two or more types of such pigments can be used in combination. The blended amount thereof differs based on the type and the like of the coloring pigment to be used, and the blended amount is usually 30 mass % or less, preferably in a range from 0.05 to 20 mass %, and more preferably in a range from 0.1 to 10 mass %, with respect to the total amount of the solid content of the resin component of the clear coating composition (Z).

The clear coating composition (Z) can be applied by a method such as electrostatic coating, air spraying, or airless spraying, and the film thickness of the clear coating film is, based on the cured coating film, approximately from 10 to 60 μm, more preferably from 15 to 50 μm, and even more preferably approximately from 20 to 40 μm.

The solid content percentage of the clear coating composition (Z) is in a range from 10 to 65 mass %, preferably in a range from 15 to 55 mass %, and more preferably in a range from 20 to 50 mass %. The viscosity of the clear coating composition (Z) is typically appropriately adjusted to a range suitable for application, which is preferably approximately in a range from 15 to 60 seconds, and particularly preferably approximately in a range from 20 to 50 seconds, at 20 °C determined by Ford viscosity cup No. 4, by using water and/or an organic solvent.

### Step (3)

According to the method of forming the multilayered coating film of the present invention, the effect coating film formed in (1) above and the clear coating film formed in (2) above are then heated separately or simultaneously to cure the coating films.

The heating can be implemented, for example, by a means such as hot air heating, infrared heating, and high frequency heating. The heating temperature is preferably from 80 to 160 °C, and more preferably from 100 to 140 °C. The heating time is preferably from 10 to 60 minutes, and more preferably from 15 to 40 minutes. Before performing the above heating and curing, heating may be performed, optionally, directly or indirectly by preheating, air blowing, or the like at a temperature of preferably approximately 50 to approximately 110 °C, and more preferably approximately 60 to approximately 90 °C, for approximately 1 to 60 minutes.

The present invention also includes the following embodiments.

### Item 1

A method of forming a multilayered coating film,
the method including:
(1) forming an effect coating film by applying an effect coating composition (Y) containing an indium particle (y1) onto an object to be coated;
(2) forming a clear coating film by applying a clear coating composition (Z) containing a hydroxy group-containing acrylic resin (z1) and a polyisocyanate compound (z2) onto the effect coating film produced in (1); and
(3) curing the effect coating film and the clear coating film by heating, separately or simultaneously, the effect coating film formed in (1) and the clear coating film formed in (2),
wherein
the hydroxy group-containing acrylic resin (z1) has a hydroxyl value in a range from 10 to 75 mg KOH/g.

### Item 2

The method of forming the multilayered coating film according to Item 1, wherein the effect coating composition (Y) further contains a hydroxy group-containing resin (y2).

### Item 3

The method of forming the multilayered coating film according to Item 1 or 2, wherein the effect coating composition (Y) further contains a melamine resin (y3).

### Item 4

The method of forming the multilayered coating film according to any one of Items 1 to 3, wherein an equivalent ratio (NCO/OH) of a total mol of an isocyanate group of the polyisocyanate compound (z2) to a total mol of a hydroxy group of the hydroxy group-containing acrylic resin (z1) is in a range from 0.7 to 1.5 in the clear coating composition (Z).

### Item 5

The method of forming the multilayered coating film according to any one of Items 1 to 4, wherein a content of the indium particle (y1) in the effect coating composition (Y) is 50 parts by mass or greater with respect to 100 parts by mass of a solid content of the effect coating composition (Y).

### Item 6

The method of forming the multilayered coating film according to any one of Items 1 to 5, wherein the content of the hydroxy group-containing resin (y2) is in a range from 0.1 to 15 parts by mass with respect to 100 parts by mass of the solid content of the effect coating composition (Y).

### Item 7

The method of forming the multilayered coating film according to Item 6, wherein the hydroxy group-containing resin (y2) contains a hydroxy group-containing acrylic resin (y2-1).

### Item 8

The method of forming the multilayered coating film according to Item 3, wherein the content of the melamine resin (y3) is in a range from 0.1 to 10 parts by mass with respect to 100 parts by mass of the solid content of the effect coating composition (Y).

### Item 9

The method of forming the multilayered coating film according to any one of Items 1 to 8, wherein the effect coating composition (Y) further contains a surface conditioner.

### Item 10

The method of forming the multilayered coating film according to Item 9, wherein the surface conditioner contains a fluorine-based surface conditioner.

### Item 11

The method of forming the multilayered coating film according to Item 9 or 10, wherein a content of the surface conditioner is in a range from 0.01 to 0.2 parts by mass with respect to 100 parts by mass of the solid content of the effect coating composition (Y).

### Item 12

The method of forming the multilayered coating film according to any one of Items 1 to 11, wherein the effect coating composition (Y) further contains an organic solvent.

### Item 13

The method of forming the multilayered coating film according to Item 12, wherein a content of the organic solvent is in a range from 85 to 99.9 parts by mass with respect to 100 parts by mass of the solid content of the effect coating composition (Y).

### Item 14

The method of forming the multilayered coating film according to any one of Items 1 to 13, wherein a solid content of the effect coating film is from 0.1 to 15 mass %.

### Item 15

The method of forming a multilayered coating film according to any one of Items 1 to 14, wherein a cured film thickness of the effect coating film is from 0.01 to 2 μm.

### Item 16

The method of forming the multilayered coating film according to any one of Items 1 to 15, wherein the object to be coated includes an outer panel part of an automobile body and an automobile part.

### EXAMPLES

The present invention will be described more specifically below with reference to examples and comparative examples. However, the present invention is not limited to these examples only. Both “parts” and “%” are based on mass.

### 1. Preparation of Substrate

A cationic electrodeposition coating material “Electron GT-10” (trade name, available from Kansai Paint Co., Ltd., a coating material in which a block polyisocyanate compound is used as a curing agent in an epoxy resin polyamine-based cation resin) was applied by electrodeposition on a degreased and zinc phosphate-treated steel sheet (JIS G 3141, a size of 400 mm×300 mm×0.8 mm) to give a film thickness of a cured coating film of 20 μm. The coating material was cross-linked and cured by heating at 170 °C for 20 minutes, and an electrodeposition coating film was formed.

On the electrodeposition coating surface of the resulting steel sheet described above, “TP-65-2” (trade name, available from Kansai Paint Co., Ltd.; polyester resin and amino resin-based organic solvent-type intermediate coating composition) was electrostatically applied by using a rotary electrostatic coater to give a cured film thickness of 35 μm, and cured by heating at 140 °C for 30 minutes, and thereby an intermediate coating film was formed for use as an object to be coated.

### 2. Production of Paint

### Production of Hydroxy Group-Containing Acrylic Resin (y2-1)

### Production Example 1

A reaction vessel equipped with a thermometer, a thermostat, a stirrer, a reflux condenser, a nitrogen inlet tube, and a dropping device was charged with 22 parts of “Swasol 1000” (trade name, available from Maruzen Petrochemical Co., Ltd., petroleum-based aromatic solvent) and 10 parts of butyl acetate, and the temperature was increased to 125 °C. Thereafter, at the same temperature, a monomer mixture containing 17 parts of 2-hydroxyethyl acrylate, 25 parts of styrene, 8 parts of n-butyl acrylate, 34.35 parts of isobutyl methacrylate, 15 parts of 2-ethylhexyl acrylate, 0.65 parts of acrylic acid, 1 part of di-tert-amyl peroxide (polymerization initiator), and 20 parts of “Swasol 1000” was added dropwise over 3 hours and aged for 2 hours after completion of the dropwise addition. Then, a mixed solution containing 0.5 parts of di-tert-amyl peroxide and 8 parts of “Swasol 1000” was added dropwise over 1 hour as an additional catalyst. After completion of the dropwise addition, the temperature was maintained at 125 °C for 1 hour, and thus a hydroxy group-containing acrylic resin solution (y2-1) having a solid content of 60% was obtained. The obtained hydroxy group-containing acrylic resin (y2-1-1) had a hydroxyl value of 82 mg KOH/g, an acid value of 5 mg KOH/g, a weight average molecular weight of 28000, and a glass transition temperature of 17 °C.

### Production of Effect Coating Composition (Y)

### Production Example 2

In a stirring and mixing container, 100 parts (solid content: 20 parts) of “LeafPowder 49CJ-1120” (trade name, available from Oike & Co., Ltd.; indium particle; solid content: 20%; dispersed in propylene glycol monomethyl ether), 0.27 parts (solid content: 0.08 parts) of “LE-605” (trade name, available from Kyoeisha Chemical Co., Ltd.; fluorine-based surface conditioner; solid content: 30%), 2.3 parts (solid content: 1.4 parts) of the hydroxy group-containing acrylic resin (y2-1-1), 0.66 parts (solid content: 0.59) of “CYMEL 327” (trade name, available from Allnex, imino group-containing melamine resin, solid content: 90%), and 1701 parts of propylene glycol monomethyl ether were added, stirred and mixed. An effect coating composition (Y-1) having a solid content of 1.2 mass % was thus produced.

### Production Examples 3 to 9

The effect coating compositions (Y-2) to (Y-8) were produced all in the same manner as in Production Example 2 except for employing formulations and solid contents listed in Table 1.

TABLE 1
Numerical values in parentheses ( ) indicate solid content.

| | | | Production Example | | | |
|---|---|---|---|---|---|---|
| Production Example No. | | | 2 | 3 | 4 | 5 |
| Name of effect coating composition | | | Y-1 | Y-2 | Y-3 | Y-4 |
| Formulation | Indium particle | “LeafPowder | 100 | 100 | 100 | 100 |
| | (y1) | 49CJ-1120” | (20) | (20) | (20) | (20) |
| | Effect pigment | “METALURE | | | | |
| | other than | L-71011AE” (*1) | | | | |
| | indium particle | | | | | |
| | (y1) | | | | | |
| | Surface | “LE-605” | 0.27 | 0.27 | 0.27 | 0.27 |
| | conditioner | | (0.08) | (0.08) | (0.08) | (0.08) |
| | Organic solvent | Propylene glycol | 1701 | 709 | | 640 |
| | | monomethyl ether | | | | |
| | | Isopropanol | | | 709 | |
| | Hydroxy group- | Hydroxy group- | 2.3 | 2.3 | 2.3 | |
| | containing resin | containing acrylic | (1.4) | (1.4) | (1.4) | |
| | (y2) | resin (y2-1-1) | | | | |
| | Melamine resin | “CYMEL 327” | 0.66 | 0.66 | 0.66 | |
| | (y3) | | (0.59) | (0.59) | (0.59) | |

| | | | | |
|---|---|---|---|---|
| Solid content (mass %) | 1.2 | 2.7 | 2.7 | 2.7 |

Production Example

| Production Example No. | | | 6 | 7 | 8 | 9 |
|---|---|---|---|---|---|---|
| Name of effect coating composition | | | Y-5 | Y-6 | Y-7 | Y-8 |
| Formulation | Indium particle | “LeafPowder | 100 | 100 | 100 | |
| | (y1) | 49CJ-1120” | (20) | (20) | (20) | |
| | Effect pigment | “METALURE | | | | 100 |
| | other than indium | L-71011AE” (*1) | | | | (10) |
| | particle (y1) | | | | | |
| | Surface | “LE-605” | 0.27 | 0.27 | 0.27 | 0.16 |
| | conditioner | | (0.08) | (0.08) | (0.08) | (0.05) |
| | Organic solvent | Propylene glycol | 690 | 660 | 386 | 340 |
| | | monomethyl ether | | | | |
| | | Isopropanol | | | | |
| | Hydroxy group- | Hydroxy group- | 2.3 | | 2.3 | 2.3 |
| | containing resin | containing acrylic | (1.4) | | (1.4) | (1.4) |
| | (y2) | resin (y2-1-1) | | | | |
| | Melamine resin | “CYMEL 327” | | 0.66 | 0.66 | 0.66 |
| | (y3) | | | (0.59) | (0.59) | (0.59) |

| | | | | |
|---|---|---|---|---|
| Solid content (mass %) | 2.7 | 2.7 | 4.5 | 2.7 |

(*1) “METALURE L-71011AE”: trade name, available from ECKART; vapor deposition aluminum flake pigment; solid content: 10%; dispersed in ethyl acetate.

### Production of Hydroxy Group-Containing Acrylic Resin (z1)

### Production Example 10

To a reaction vessel equipped with a thermometer, a thermostat, a stirrer, a reflux condenser, a nitrogen-introducing tube, and a dropping device, 27 parts of “Swasol 1000” (trade name, available from Cosmo Oil Co., Ltd., aromatic organic solvent) and 5 parts of propylene glycol monomethyl ether acetate were charged. While nitrogen gas was blown into the reaction vessel, the liquid placed inside the reaction vessel was stirred at 150 °C, and a monomer mixture containing 20 parts of styrene, 10.5 parts of n-butyl acrylate, 3.5 parts of 2-hydroxyethyl methacrylate, 50 parts of isobutyl methacrylate, 15 parts of 2-ethylhexyl acrylate, 1.0 part of acrylic acid, and 1.5 parts of di-tert-amyl peroxide (polymerization initiator) was added dropwise to the liquid at a steady rate over 4 hours. Thereafter, the mixture was aged at 150 °C for 1 hour, then cooled, and further diluted with 21 parts of isobutyl acetate, and a hydroxy group-containing acrylic resin (z1-1) solution having a solid content concentration of 65 mass % was produced. The obtained hydroxy group-containing acrylic resin (z1-1) had a hydroxyl value of 15 mg KOH/g, an acid value of 8 mg KOH/g, a weight average molecular weight of 30000, and a glass transition temperature of 24 °C.

### Production Examples 11 to 15

Solutions of hydroxy group-containing acrylic resins (z1-2) to (z1-6) respectively, each having a solid content concentration of 65 mass %, were produced in the same manner as in Production Example 10 except that the formulation in Production Example 10 was changed to those listed in Table 2. The acid value, hydroxyl value, weight average molecular weight, and glass transition temperature of each of the hydroxy group-containing acrylic resins are listed in Table 2.

TABLE 2
[Table 3]

| Production Example | | | 10 | 11 | 12 |
|---|---|---|---|---|---|
| Name of hydroxy group-containing acrylic resin (z1) | | | z1-1 | z1-2 | z1-3 |
| Monomer | Acid group-containing | Acrylic acid | 1 | 1 | 1 |
| mixture | polymerizable | | | | |
| | unsaturated monomer | | | | |
| | Hydroxy group- | 2-hydroxyethyl methacrylate | 3.5 | 10 | |
| | containing | 2-Hydroxypropyl acrylate | | | 10 |
| | polymerizable | | | | |
| | unsaturated monomer | | | | |
| | Other polymerizable | Styrene | 20 | 20 | 25 |
| | unsaturated monomers | n-Butyl acrylate | 10.5 | 10.5 | 5.5 |
| | | Isobutyl methacrylate | 50 | 43.5 | 43.5 |
| | | 2-Ethylhexyl acrylate | 15 | 15 | 15 |

| | | | | |
|---|---|---|---|---|
| Polymerization initiator | Di-tert-amyl peroxide | 1.5 | 1.5 | 1.5 |

| | | | |
|---|---|---|---|
| Hydroxyl value (mg KOH/g) | 15 | 43 | 43 |
| Acid value (mg KOH/g) | 8 | 8 | 8 |
| Weight average molecular weight | 30000 | 30000 | 30000 |
| Glass transition temperature (°C) | 24 | 24 | 26 |

[Table 4]

| Production Example | | | 13 | 14 | 15 |
|---|---|---|---|---|---|
| Name of hydroxy group-containing acrylic resin (z1) | | | z1-4 | z1-5 | z1-6 |
| Monomer | Acid group-containing | Acrylic acid | 1 | 1 | 1 |
| mixture | polymerizable | | | | |
| | unsaturated monomer | | | | |
| | Hydroxy group- | 2-hydroxyethyl methacrylate | 16.5 | 1.6 | 19 |
| | containing | 2-Hydroxypropyl acrylate | | | |
| | polymerizable | | | | |
| | unsaturated monomer | | | | |
| | Other polymerizable | Styrene | 20 | 20 | 20 |
| | unsaturated monomers | n-Butyl acrylate | 10.5 | 10.5 | 10.5 |
| | | Isobutyl methacrylate | 37 | 51.9 | 34.5 |
| | | 2-Ethylhexyl acrylate | 15 | 15 | 15 |

| | | | | |
|---|---|---|---|---|
| Polymerization initiator | Di-tert-amyl peroxide | 1.5 | 1.5 | 1.5 |

| | | | |
|---|---|---|---|
| Hydroxyl value (mg KOH/g) | 71 | 7 | 82 |
| Acid value (mg KOH/g) | 8 | 8 | 8 |
| Weight average molecular weight | 30000 | 30000 | 30000 |
| Glass transition temperature (°C) | 24 | 24 | 24 |

### Production of Clear Coating Composition (Z-1)

### Production Example 16

Immediately before application, a main agent obtained by uniformly mixing 144.9 parts (solid content: 94.2 parts) of the hydroxy group-containing acrylic resin (z1-1) solution obtained in Production Example 10 and 0.4 parts (solid content: 0.2 parts) of “BYK-300” (trade name, available from BYK-Chemie, surface conditioner, active component: 52%) and

5.8 parts (solid content: 5.8 parts) of “Sumidur N3300” (trade name, available from Sumika Covestro Urethane Company, Ltd., isocyanurate of hexamethylene diisocyanate, solid content: 100%) as a curing agent were uniformly mixed. To this mixture, butyl acetate was added, and the viscosity thereof was adjusted in a manner that the viscosity at 20 °C determined by Ford viscosity cup No. 4 became 30 seconds. Thus, a clear coating composition (Z-1) was obtained.

### Production Examples 17 to 23

The clear coating compositions (Z-2) to (Z-8) were produced all in the same manner as in Production Example 16 except for employing formulations listed in Table 3.

TABLE 3

| Production Example | | 16 | 17 | 18 | 19 |
|---|---|---|---|---|---|
| Name of clear coating material (Z) | | Z-1 | Z-2 | Z-3 | Z-4 |
| Hydroxy group- | Hydroxy group-containing | 94.2 | | | |
| containing acrylic | acrylic resin (z1-1) | | | | |
| resin (z1) | Hydroxy group-containing | | 85.0 | 89.4 | 82.9 |
| | acrylic resin (z1-2) | | | | |
| | Hydroxy group-containing | | | | |
| | acrylic resin (z1-3) | | | | |
| | Hydroxy group-containing | | | | |
| | acrylic resin (z1-4) | | | | |
| | Hydroxy group-containing | | | | |
| | acrylic resin (z1-5) | | | | |
| | Hydroxy group-containing | | | | |
| | acrylic resin (z1-6) | | | | |
| Polyisocyanate | “Sumidur N3300” | 5.8 | 15.0 | 10.6 | 17.1 |
| Compound (z2) | | | | | |
| Surface conditioner | BYK-300 | 0.2 | 0.2 | 0.2 | 0.2 |
| Equivalent ratio (NCO/OH) of total mol of | | 1.2 | 1.2 | 0.8 | 1.4 |
| isocyanate group of polyisocyanate compound | | | | | |
| (z2) to total mol of hydroxy group of | | | | | |
| hydroxy group-containing acrylic resin (z1) | | | | | |
| Production Example | | 20 | 21 | 22 | 23 |
| Name of clear coating material (Z) | | Z-5 | Z-6 | Z-7 | Z-8 |
| Hydroxy group- | Hydroxy group-containing | | | | |
| containing acrylic | acrylic resin (z1-1) | | | | |
| resin (z1) | Hydroxy group-containing | | | | |
| | acrylic resin (z1-2) | | | | |
| | Hydroxy group-containing | 85.0 | | | |
| | acrylic resin (z1-3) | | | | |
| | Hydroxy group-containing | | 77.4 | | |
| | acrylic resin (z1-4) | | | | |
| | Hydroxy group-containing | | | 97.2 | |
| | acrylic resin (z1-5) | | | | |
| | Hydroxy group-containing | | | | 74.8 |
| | acrylic resin (z1-6) | | | | |
| Polyisocyanate | “Sumidur N3300” | 15.0 | 22.6 | 2.8 | 25.2 |
| Compound (z2) | | | | | |
| Surface conditioner | BYK-300 | 0.2 | 0.2 | 0.2 | 0.2 |

| | | | | |
|---|---|---|---|---|
| Equivalent ratio (NCO/OH) of total mol of | 1.2 | 1.2 | 1.2 | 1.2 |
| isocyanate group of polyisocyanate compound | | | | |
| (z2) to total mol of hydroxy group of | | | | |
| hydroxy group-containing acrylic resin (z1) | | | | |

### 3. Preparation of Test Sheet

### Preparation of Test Sheet

### Example 1

On a substrate prepared in “1. Preparation of Substrate” described above, the effect coating composition (Y-1) produced in “2. Preparation of Coating Material” described above was applied by using a minibell rotary electrostatic coater at a booth temperature of 23 °C and humidity of 63% in a manner that the film thickness as a cured coating film became 0.05 μm, allowed to stand for 15 minutes at room temperature, then heated in a hot air circulation type drying furnace at 140 °C for 30 minutes, and dried and cured. An effect coating film was thus produced.

Thereafter, on the effect coating film described above, the clear coating composition (Z-2) adjusted in “2. Preparation of Coating Material” described above was applied by using a minibell rotary electrostatic coater at a booth temperature of 23 °C and humidity of 68% in a manner that the film thickness as a cured coating film became 35 μm, allowed to stand for 7 minutes at room temperature, then heated in a hot air circulation type drying furnace at 140 °C for 30 minutes, and dried and cured. A test sheet of Example 1 was thus produced.

Here, the dry coating film thickness of the effect coating film was calculated from the following equation. The same applies to the following examples.

x=sc/sg/S*10000
x: Film thickness [μm]
sc: Solid content [g] coated by application
sg. Specific gravity of coating film [g/cm³]
S: Evaluated surface area [cm²] of the solid content coated by application

### Examples 2 to 7 and 9 to 13 and Comparative Examples 1 to 3

Test sheets were produced all in the same manner as in Example 1 except for coating materials and film thicknesses listed in Table 4.

### Example 8

On a substrate prepared in “1. Preparation of Substrate” described above, the effect coating composition (Y-2) produced in “2. Preparation of Coating material” described above was applied by using a minibell rotary electrostatic coater at a booth temperature of 23 °C and humidity of 63% in a manner that the film thickness as a cured coating film became 0.1 μm, allowed to stand for 15 minutes at room temperature, and then pre-heated in a hot air circulation type drying furnace at 80 °C for 3 minutes. An uncured effect coating film was thus produced.

Thereafter, on the uncured effect coating film described above, the clear coating composition (Z-2) adjusted in “2. Preparation of Coating Material” described above was applied by using a minibell rotary electrostatic coater at a booth temperature of 23 °C and humidity of 68% in a manner that the film thickness as a cured coating film became 35 μm, allowed to stand for 7 minutes at room temperature, and then heated in a hot air circulation type drying furnace at 140 °C for 30 minutes to simultaneously dry and cure the effect coating film and the clear coating film. A test sheet of Example 8 was thus produced.

### Coating Film Evaluation

The coating film was evaluated by the following methods for each test sheet produced as described above, and the results are listed in Table 4.

### Initial Adhesion After Water Exposure

The test sheet was immersed in 40 °C warm water for 240 hours and then retrieved, then the moisture and dirt were wiped off by cloth and, within 10 minutes and at room temperature of 23 °C, a grid-like cut was made on the multilayered coating film of the test sheet by a utility knife in a manner that the cut reached the base material, and thus a grid of 100 pieces each having a size of 2 mm×2 mm was made. Then, a cellophane adhesive tape was adhered to the surface. The adhesive tape was quickly peeled off, then a remaining state of the cross cut coating film was examined, and the initial adhesion after water exposure was evaluated according to the criteria below. A and B are acceptable.
A: 100 pieces of the grid of the coating film remained, and no small chipping on edges occurred in the coating film at edges of cutting made by the utility knife.
B: Although 100 pieces of the grid of the coating film remained, small chipping on edges occurred in the coating film at edges of cutting made by the utility knife, and the number of pieces of remained and chipped coating film was less than 10 pieces.
C: Although 100 pieces of the grid of the coating film remained, small chipping on edges occurred in the coating film at edges of cutting made by the utility knife, and the number of pieces of remained and chipped coating film was 10 pieces or more.
D: From 90 to 99 pieces of the grid of the coating film remained.
E: The number of pieces remained of the grid of the coating film was 89 or less.

### Adhesion After Water Exposure After Accelerated Weathering Test

For the accelerated weathering test, by using Super Xenon Weather Meter (trade name, available from Suga Test Instruments Co., Ltd.) stipulated in JIS B 7754, a two-hour cycle of 1 hour and 42 minutes of irradiation by a xenon arc lamp and 18 minutes of irradiation by the same lamp in the rainy conditions was repeated for 2000 hours, and then the operation the same as that for the adhesion after water exposure described above was performed. A, B and C are acceptable.

### Specular Gloss (60° Gloss)

A 60° gloss value was measured using a gloss meter (micro-TRI-gloss, available from BYK-Gardner GmbH). A larger value indicates superior metallic luster. A value of 280 or greater is acceptable.

TABLE 4

| | Example | | | | | | | |
|---|---|---|---|---|---|---|---|---|
| | 1 | 2 | 3 | 4 | 5 | 6 | 7 | 8 |
| Name of effect | Y-1 | Y-2 | Y-2 | Y-2 | Y-2 | Y-2 | Y-2 | Y-2 |
| coating | | | | | | | | |
| composition (Y) | | | | | | | | |
| Film thickness | 0.05 | 0.10 | 0.10 | 0.10 | 0.10 | 0.10 | 0.10 | 0.10 |
| (μm) of effect | | | | | | | | |
| coating film | | | | | | | | |
| Heating of effect | 140 °C/ | 140 °C/ | 140 °C/ | 140 °C/ | 140 °C/ | 140 °C/ | 140 °C/ | 80 °C/ |
| coating film | 30 min | 30 min | 30 min | 30 min | 30 min | 30 min | 30 min | 3 min |
| Name of clear | Z-2 | Z-1 | Z-2 | Z-3 | Z-4 | Z-5 | Z-6 | Z-2 |
| coating | | | | | | | | |
| composition (Z) | | | | | | | | |
| Initial adhesion | A | A | A | A | A | A | A | A |
| after water | | | | | | | | |
| exposure | | | | | | | | |
| Adhesion after | A | A | A | A | A | A | C | A |
| water exposure | | | | | | | | |
| after accelerated | | | | | | | | |
| weathering test | | | | | | | | |
| Specular gloss | 302 | 348 | 319 | 358 | 322 | 317 | 352 | 298 |
| (60° gloss) | | | | | | | | |
| | Example | | | | | Comparative Example | | |
| | 9 | 10 | 11 | 12 | 13 | 1 | 2 | 3 |
| Name of effect | Y-3 | Y-4 | Y-5 | Y-6 | Y-7 | Y-8 | Y-2 | Y-2 |
| coating | | | | | | | | |
| composition (Y) | | | | | | | | |
| Film thickness | 0.10 | 0.10 | 0.10 | 0.10 | 0.20 | 0.10 | 0.10 | 0.10 |
| (μm) of effect | | | | | | | | |
| coating film | | | | | | | | |
| Heating of effect | 140 °C/ | 140 °C/ | 140 °C/ | 140 °C/ | 140 °C/ | 140 °C/ | 140 °C/ | 140 °C/ |
| coating film | 30 min | 30 min | 30 min | 30 min | 30 min | 30 min | 30 min | 30 min |
| Name of clear | Z-2 | Z-2 | Z-2 | Z-2 | Z-2 | Z-2 | Z-7 | Z-8 |
| coating | | | | | | | | |
| composition (Z) | | | | | | | | |
| Initial adhesion | A | A | A | A | A | E | A | A |
| after water | | | | | | | | |
| exposure | | | | | | | | |
| Adhesion after | A | C | B | B | A | E | D | E |
| water exposure | | | | | | | | |
| after accelerated | | | | | | | | |
| weathering test | | | | | | | | |
| Specular gloss | 291 | 365 | 353 | 357 | 282 | 294 | 343 | 347 |
| (60° gloss) | | | | | | | | |

Although embodiments and examples of the present invention have been specifically described above, the present invention is not limited to the embodiments described above, and various modifications based on the technical idea of the present invention are possible.

For example, the configurations, methods, processes, shapes, materials, numerical values, and the like given in the above-described embodiments and examples are merely examples, and different configurations, methods, processes, shapes, materials, numerical values, and the like may be used.

Also, the configurations, methods, processes, shapes, materials, numerical values, and the like of the above-described embodiments can be combined with each other without departing from the gist of the present invention.

1. A method of forming a multilayered coating film,
the method comprising:
(1) forming an effect coating film by applying an effect coating composition (Y) containing an indium particle (y1) onto an object to be coated;
(2) forming a clear coating film by applying a clear coating composition (Z) containing a hydroxy group-containing acrylic resin (z1) and a polyisocyanate compound (z2) onto the effect coating film produced in (1); and
(3) curing the effect coating film and the clear coating film by heating, separately or simultaneously, the effect coating film formed in (1) and the clear coating film formed in (2),
wherein
the hydroxy group-containing acrylic resin (z1) has a hydroxyl value in a range from 10 to 75 mg KOH/g.

2. The method of forming the multilayered coating film according to claim 1, wherein the effect coating composition (Y) further contains a hydroxy group-containing resin (y2).

3. The method of forming the multilayered coating film according to claim 1, wherein the effect coating composition (Y) further contains a melamine resin (y3).

4. The method of forming the multilayered coating film according to claim 1, wherein an equivalent ratio (NCO/OH) of a total mol of an isocyanate group of the polyisocyanate compound (z2) to a total mol of a hydroxy group of the hydroxy group-containing acrylic resin (z1) is in a range from 0.7 to 1.5 in the clear coating composition (Z).

5. The method of forming the multilayered coating film according to claim 2, wherein the effect coating composition (Y) further contains a melamine resin (y3).

6. The method of forming the multilayered coating film according to claim 2, wherein an equivalent ratio (NCO/OH) of a total mol of an isocyanate group of the polyisocyanate compound (z2) to a total mol of a hydroxy group of the hydroxy group-containing acrylic resin (z1) is in a range from 0.7 to 1.5 in the clear coating composition (Z).

7. The method of forming the multilayered coating film according to claim 3, wherein an equivalent ratio (NCO/OH) of a total mol of an isocyanate group of the polyisocyanate compound (z2) to a total mol of a hydroxy group of the hydroxy group-containing acrylic resin (z1) is in a range from 0.7 to 1.5 in the clear coating composition (Z).

8. The method of forming the multilayered coating film according to claim 5, wherein an equivalent ratio (NCO/OH) of a total mol of an isocyanate group of the polyisocyanate compound (z2) to a total mol of a hydroxy group of the hydroxy group-containing acrylic resin (z1) is in a range from 0.7 to 1.5 in the clear coating composition (Z).
